(19) United States
(12) Patent Application Publication
(10) Pub. No.: US 2018/0114363 A1
(43) Pub. Date: Apr. 26, 2018

(54) AUGMENTED SCANNING OF 3D MODELS

(71) Applicant: MICROSOFT TECHNOLOGY LICENSING, LLC, Redmond, WA (US)

(72) Inventor: OMER ROSENBAUM, Redmond, WA (US)

(21) Appl. No.: 15/459,509

(22) Filed: Mar. 15, 2017

Related U.S. Application Data
(60) Provisional application No. 62/412,757, filed on Oct. 25, 2016.

(51) Int. Cl. G06T 17/20; G06T 19/00; G06T 15/04; G06T 13/20; H04N 13/02

(52) U.S. Cl. CPC G06T 17/20; G06T 19/006; G06T 15/04; G06T 2200/04; H04N 13/0207; G06T 2200/24; G06T 13/20

(57) ABSTRACT

The present disclosure provides approaches to augmenting scanning of 3D models with reference objects. In some implementations, a user device initiates a scan of a physical environment where the scan produces a live feed of scan data corresponding to the physical environment. A 3D representation of the physical environment is generated from the live feed of scan data. The scan data is matched to at least one reference 3D object during the scan of the physical environment. The 3D representation is augmented with 3D geometry of the at least one reference 3D object based on the matching. The augmented 3D representation may be displayed on the user device.

### CROSS-REFERENCE TO RELATED APPLICATIONS

This application claims the benefit of U.S. Provisional Application No. 62/412,757, titled “Augmented Scanning of 3D Models,” filed Oct. 25, 2016, which is hereby expressly incorporated by reference in its entirety.

### BACKGROUND

Three-Dimensional (3D) scanning technologies allow real-world objects and environments to be converted into corresponding 3D virtual objects. The 3D virtual objects have many possible uses such as for 3D printing, augmented reality (AR) and virtual reality (VR) experiences, rapid prototyping, and more. Typically, a 3D virtual object may be generated by scanning the environment with one or more scanning devices, which include any number of environmental sensors capable of detecting physical features of the real-world. These physical features are translated into corresponding features of the 3D virtual object.

In some cases, the 3D object(s) produced by a scan may be incomplete or inaccurate. This could be from environmental conditions that make it difficult to detect physical features, such as insufficient lighting, proximity, and the like. Furthermore, scanning devices can vary widely in terms sensing capabilities, making it difficult to determine ideal scanning conditions for a particular device. As another factor, in some cases, scanning devices may not have access to some angles of real-world objects, leaving gaps in the sensed data. These various complications can result in defects to 3D virtual objects produced from the 3D scanning such as missing parts or holes in the model or pixel tearing of textures. Thus, due to insufficient environmental information from scanning devices, it may not be possible to accurately complete reproductions of the physical environment.

### SUMMARY

In some respects, the present disclosure provides systems and methods of visualization and generation of 3D scanned objects using both 3D captured data from a real world object and an extrapolated completion of the object using data from at least one mesh fitted library object. Merging the scanned mesh with the extrapolated library object enables the user to auto-complete areas that are harder or impossible to scan and create a better result. When performed in real-time during scanning, the object completion can assist the user's decision whether to skip scanning for an area or attempt to scan it more thoroughly. For example, if the user rotates and otherwise inspects the 3D model and it looks complete, the user may terminate scanning.

### BRIEF DESCRIPTION OF THE DRAWINGS

The present invention is described in detail below with reference to the attached drawing figures, wherein:

FIG. 1 is a block diagram showing an example of an operating environment, in accordance with embodiments of the present disclosure;

FIG. 2 shows a block diagram of a scan augmenter, in accordance with embodiments of the present disclosure;

FIG. 3A shows a display of scanned geometry, in accordance with embodiments of the present disclosure;

FIG. 3B shows a display of scanned geometry augmented based on a reference object, in accordance with embodiments of the present disclosure;

FIG. 4A shows a display of scanned geometry, in accordance with embodiments of the present disclosure;

FIG. 4B shows a display of scanned geometry augmented based on a reference object, in accordance with embodiments of the present disclosure;

FIG. 5 is a flow diagram showing a method in accordance with embodiments of the present disclosure;

FIG. 6 is a flow diagram showing a method in accordance with embodiments of the present disclosure;

FIG. 7 is a flow diagram showing a method in accordance with embodiments of the present disclosure; and

FIG. 8 is a block diagram of an exemplary computing environment suitable for use in implementing embodiments of the present disclosure

### DETAILED DESCRIPTION

The subject matter of the present invention is described with specificity herein to meet statutory requirements. However, the description itself is not intended to limit the scope of this disclosure. Rather, the inventors have contemplated that the subject matter might also be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described.

The process of 3D scanning can be cumbersome and time consuming. Often after completing a 3D scan the resulting 3D model has missing parts or “holes.” To correct the holes, one could apply interpolations or curve matching, which may achieve acceptable results for small areas with simple surface curvatures. However, these approaches perform poorly for larger areas or areas where a limited amount of surrounding geometry information exists.

Aspects of the present disclosure can remedy the deficiencies of prior approaches by automatically matching (e.g., during a live or real-time scanning process) a partial scanned 3D model or a model with large holes in it to an existing model to provide more accurate surface reconstruction or an otherwise enhanced scanned 3D virtual object. Further, scene matching to a library object may be employed to augment a 2.5D environment captured by stereo cameras or one captured with severe restrictions on the scene coverage. Enhancing this data can be used to remove or prevent “pixel stretching” that often happens due to a lack of scanned environmental features behind certain objects. The automatic matching described herein may optionally employ GPS data to understand what other users have scanned in an area currently being scanned and try to match to those objects (e.g., in real-time while an environment is being scanned).

The library objects used for matching to scanned 3D geometry (e.g., for mesh fitting) can include but is not limited to: basic primitives (e.g. cubes, spheres), stock objects that have geometric similarities with a scanned mesh (e.g. table, chair, face), and/or a model of the same actual object(s) scanned previously. In order to auto-complete textures for scanned 3D virtual objects, a library object texture may be used to infer the texture using the surrounding textures and smooth transitions may be produced between them. As another approach, a wireframe of the 3D object could be used without texture or a solid colored textures could be employed.

If a user were to scan a model with an RGB camera on a phone to reproduce it in 3D, sometimes the scanning system does not have access to all the angles of the object. The object could be in a museum and the user is not permitted to get behind it, for example. In some cases, the object itself may be broken and missing some pieces. Aspects of the present disclosure can be used to produce complete scanned 3D virtual objects in these types of situations.

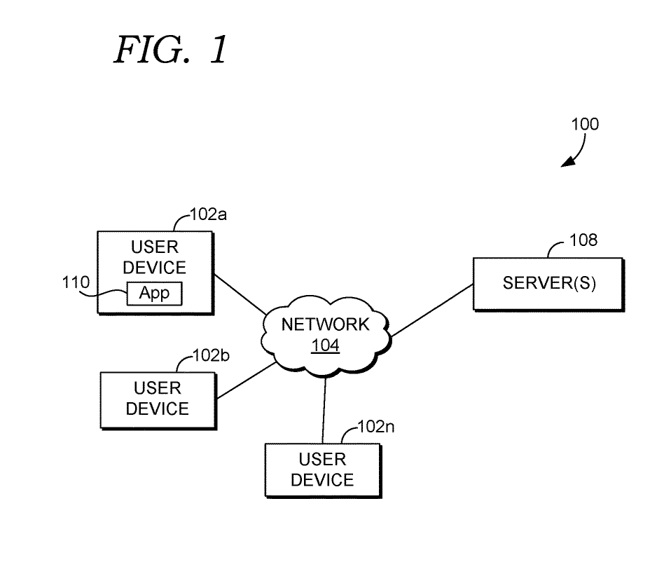

Turning now to FIG. 1, a block diagram is provided showing an example of an operating environment in which some implementations of the present disclosure can be employed. It should be understood that this and other arrangements described herein are set forth only as examples. Other arrangements and elements (e.g., machines, interfaces, functions, orders, and groupings of functions, etc.) can be used in addition to or instead of those shown, and some elements may be omitted altogether for the sake of clarity. Further, many of the elements described herein are functional entities that may be implemented as discrete or distributed components or in conjunction with other components, and in any suitable combination and location. Various functions described herein as being performed by one or more entities may be carried out by hardware, firmware, and/or software. For instance, some functions may be carried out by a processor executing instructions stored in memory.

Among other components not shown, operating environment 100 includes a number of user devices, such as user devices 102a and 102b through 102n, network 104, and server(s) 108.

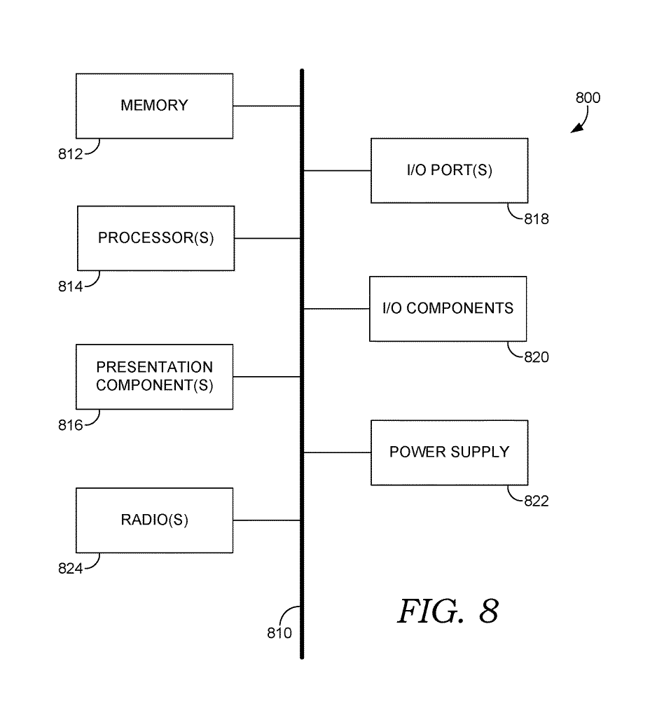

It should be understood that operating environment 100 shown in FIG. 1 is an example of one suitable operating environment. Each of the components shown in FIG. 1 may be implemented via any type of computing device, such as one or more of computing device 800 described in connection to FIG. 8, for example. These components may communicate with each other via network 104, which may be wired, wireless, or both. Network 104 can include multiple networks, or a network of networks, but is shown in simple form so as not to obscure aspects of the present disclosure. By way of example, network 104 can include one or more wide area networks (WANs), one or more local area networks (LANs), one or more public networks such as the Internet, and/or one or more private networks. Where network 104 includes a wireless telecommunications network, components such as a base station, a communications tower, or even access points (as well as other components) may provide wireless connectivity. Networking environments are commonplace in offices, enterprise-wide computer networks, intranets, and the Internet. Accordingly, network 104 is not described in significant detail.

It should be understood that any number of user devices, servers, and other disclosed components may be employed within operating environment 100 within the scope of the present disclosure. Each may comprise a single device or multiple devices cooperating in a distributed environment.

User devices 102a through 102n comprise any type of computing device capable of being operated by a user. For example, in some implementations, user devices 102a through 102n are the type of computing device described in relation to FIG. 8 herein. By way of example and not limitation, a user device may be embodied as a personal computer (PC), a laptop computer, a mobile device, a smartphone, a tablet computer, a smart watch, a wearable computer, a personal digital assistant (PDA), an MP3 player, a global positioning system (GPS) or device, a video player, a handheld communications device, a gaming device or system, an entertainment system, a vehicle computer system, an embedded system controller, a remote control, an appliance, a consumer electronic device, a workstation, a 3D scanning device, any combination of these delineated devices, or any other suitable device.

The user devices can include one or more processors, and one or more computer-readable media. The computer-readable media may include computer-readable instructions executable by the one or more processors. The instructions may be embodied by one or more applications, such as application 110 shown in FIG. 1. Application 110 is referred to as a single application for simplicity, but its functionality can be embodied by one or more applications in practice. As indicated above, the other user devices can include one or more applications similar to application 110.

The application(s) may generally be any application capable of facilitating the exchange of information between the user devices and the server(s) 108 in carrying out 3D scanning. In some implementations, the application(s) comprises a web application, which can run in a web browser, and could be hosted at least partially on the server-side of operating environment 100. In addition, or instead, the application(s) can comprise a dedicated application, such as an application having image processing functionality. In some cases, the application is integrated into the operating system (e.g., as one or more services). It is therefore contemplated herein that “application” be interpreted broadly.

Server(s) 108 also includes one or more processors, and one or more computer-readable media. The computer-readable media includes computer-readable instructions executable by the one or more processors.

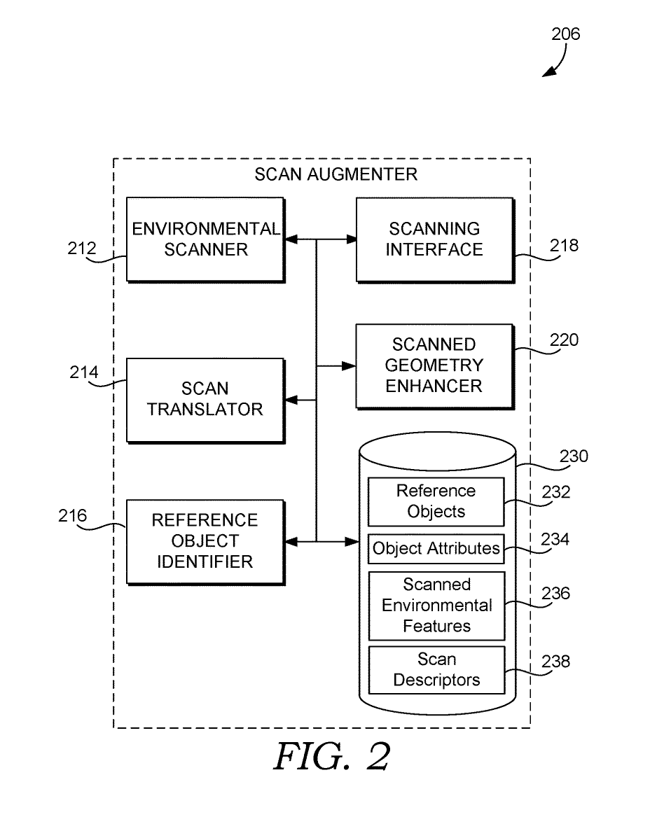

Any combination of the instructions of server (108) and/or user devices 102a through 102n may be utilized to implement one or more components of scan augmenter 206 of FIG. 2, which is described in additional detail below.

Referring to FIG. 2, a block diagram of a scan augmenter is shown, in accordance with embodiments of the present disclosure. Scan augmenter 206 includes environmental scanner 212, scan translator 214, reference object identifier 216, scanning interface 218, scanned environment enhancer 220, and storage 230. As indicated above, the foregoing components of scan augmenter 206 can be implemented, for example, in operating environment 100 of FIG. 1. In particular, those components may be integrated into any suitable combination of user devices 102a and 102b through 102n, and server(s) 108. For cloud-based implementations, the instructions on server 108 may implement one or more components or portions thereof of scan augmenter 206, and application 110 may be utilized by a user to interface with the functionality implemented on server(s) 108. In some cases, server 108 may not be required. For example, the components of scan augmenter 206 may be implemented completely on a user device, such as user device 102a. In these cases, scan augmenter 206 may be embodied at least partially by the instructions corresponding to application 110.

Thus, it should be appreciated that scan augmenter 206 may be provided via multiple devices arranged in a distributed environment that collectively provide the functionality described herein. Additionally, other components not shown may be included within the distributed environment. In addition, or instead, scan augmenter 206 can be integrated, at least partially, into a user device, such as user device 102a. Furthermore, scan augmenter 206 may at least partially be embodied as a cloud computing service.

Storage 230 can comprise computer-readable media and is configured to store computer instructions (e.g., software program instructions, routines, or services), data, and/or models used in embodiments described herein. In some implementations, storage 230 stores information or data received via the various components of scan augmenter 206 and provides the various components with access to that information or data, as needed. In implementations, storage 230 comprises a data store (or computer data memory). Although depicted as a single component, storage 230 may be embodied as one or more data stores and may be at least partially in the cloud. Further, the information in storage 230 may be distributed in any suitable manner across one or more data stores for storage (which may be hosted externally).

In the implementation shown, storage 230 includes at least reference objects 232, object attributes 234, scanned environmental features 236, and scan descriptors 238, which are described in further detail below.

As an overview, scanning interface 218 provides a user interface to environmental scanner 212, which is operable to collect sensor data from one or more sensors via one or more devices, such as one or more of user devices 102a through 102n in FIG. 1. Scan translator 214 analyzes the sensor data and translates the sensor data into scanned environmental features 236. Scanned environmental features 236 includes at least scanned geometry features and optionally scanned attribute features (e.g., textures, colors, sounds, movements, animations, and the like) for 3D objects. Reference object identifier 216 determines one or more of reference objects 232 that corresponds to scanned environmental features 236, such as based on comparisons between features of reference objects and scanned environmental features 236 (e.g., between geometry features). Scanned environment enhancer 220 is configured to augment scanned environmental features 236 using the one or more of reference objects 232 determined or identified by reference object identifier 216.

Augmenting scanned environmental features 236 can include incorporating at least some of the geometry of the one or more of reference objects 232 therein, modifying scanned geometry therein based on at least some of the geometry of the one or more of reference objects 232, and/or replacing scanned geometry therein with at least some of the geometry of the one or more of reference objects 232. In addition or instead, this can include based on the one or more of reference objects 232, incorporating in scanned environmental features 236 at least some of object attributes 234, modifying scanned attributes therein based on one or more of object attributes 234, and/or replacing scanned attributes therein with one or more of object attributes 234.

The augmentations for scanned environmental features 236 may be presented to the user (e.g., with at least some of scanned environmental features 236), such as using scanning interface 218, where the user may optionally be allowed to adopt, reject, view, and/or selected between any combinations of the various augmentations, including options for augmented object features.

As mentioned above, scanning interface 218 provides a user interface to environmental scanner 212. Scanning interface 218 can, for example, correspond to application 110 of FIG. 1 and include a graphical user interface (GUI) or other suitable interface to assist the user in capturing physical environmental features via environmental scanner. Scanning interface 218 can, for example, allow the user to selectively activate or deactivate environmental scanning by environmental scanner 212.

In some cases, the GUI of scanning interface 218 displays the physical environment, such as via a live feed or real-time feed from one or more cameras. In addition or instead, scan data generated by environmental scanner 212 and translated into scanned environmental features 236 by scan translator 214 may be displayed in the GUI. This can include display of 3D geometry for one or more virtual objects, which may be depicted in the GUI using wireframes, meshes, polygons, voxels, and/or other visual representations of the scanned geometry data. This can also include display or presentation of scanned environmental attributes for the one or more virtual objects, such as textures, colors, sounds, animations, movements, and the like. In some cases, scanning interface 218 overlays or renders one or more of these scanned environmental features over the display of the physical environment, such as a live feed of the physical environment from a camera. In others, the physical environment may not necessarily be displayed in the GUI or displayed concurrently with these features.

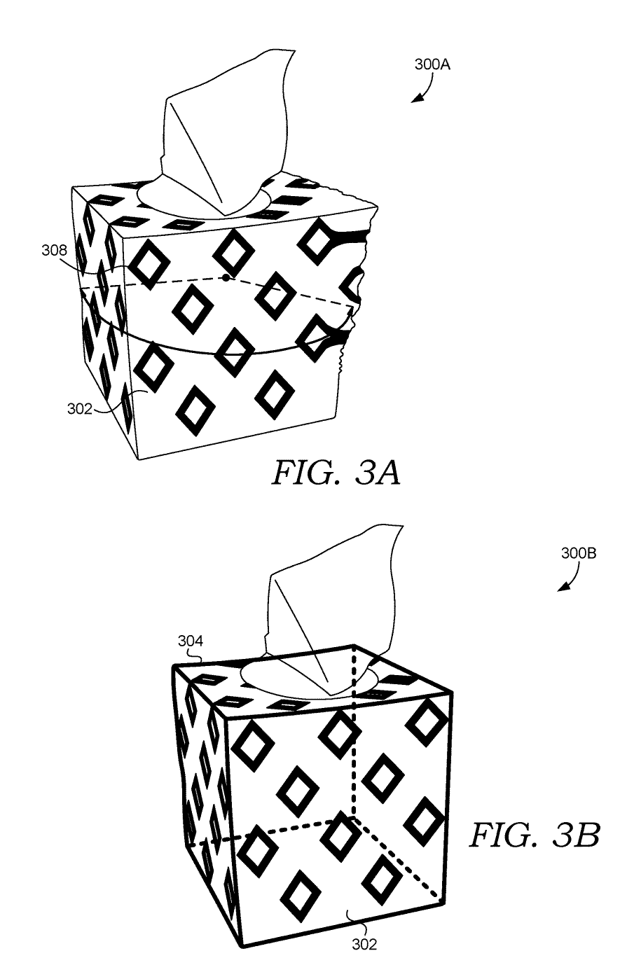

FIG. 3A shows an example of a display of scanned environmental features in a scanning interface. In particular display 300A is one example of what may be presented by scanning interface 218 of FIG. 2 in order to present some of scanned environmental features 236. Display 300A presents scanned geometry features and scanned attribute features of the scanned environmental features for scanned virtual object 302. As shown, the scanning interface has rendered visual representations of these scanned environmental features for display to the user.

Any suitable approach can be used for scanning the physical environmental in order to generate scanned environmental features for one or more 3D virtual objects. In some approaches, the user manipulates or physically positions one or more user devices, such as user device 102a, in order to allow environmental scanner 212 to capture different perspectives of the environment. For example, the user may adjust the angle, rotation, or orientation of a user device with respect to the environment as a whole and/or with respect to a region or corresponding real world object the user wishes to scan. In some cases, one or more environmental snapshots are taken at these various device positions. For example, the user may selectively capture each environmental snapshot via scanning interface 218. As another example, a stream of environmental data could be captured via environmental scanner 212.

This environmental data is provided by one or more sensors integrated into or external to one or more user devices. Examples of suitable sensors to capture environmental data include any combination of a depth sensor, a camera, a pressure sensor, an RGB camera, a depth-sensing camera, a pressure sensor, an IR sensor, and the like. As indicated above, environmental scanner 212 manages these sensors to facilitate the capture of the environmental data.

Scan translator 214 is configured to convert the environmental data into scanned environmental features, such as scanned environmental features 236. A scanned environmental feature refers to a digital representation of a real environmental feature. This can include geometry features which correspond to real world geometry, and attribute features which correspond to real attributes of the environmental. Scan translator can analyze the environmental data and determine geometry features, or geometry, from sensor data which captures the physical geometry of the environment. Scan translator 214 can also determine attribute features, each of which it may associate with one or more of the geometry features (e.g., texture may be mapped to geometry). In some cases, scan translator 214 updates one or more scanned environmental features 236 as more environmental data is received during or after a scan.

Many suitable approaches are known for capturing and digitally representing physical environmental features, any of which may be suitable for use in implementations of the present disclosure. Optionally, scan translator 214 may create associations between 3D virtual objects and the scanned environmental features. For example, different subsets of scanned environmental features may be associated with different virtual objects. However, scan translator 214 need not specifically identify and designate virtual objects.

In some implementations, scan translator 214 further converts the environmental data into one or more scan descriptors, such as scan descriptors 238. Scan descriptors 238 correspond to scanned environmental features 236, and generally describe the conditions under which the environmental data corresponding to scanned environmental features 236 were captured. Scan descriptors can, for example, be determined from sensor data to represent one or more angles, rotations, or orientations of the user device(s), or sensors, used to capture the environmental data, with respect to the environment as a whole and/or with respect to a region or corresponding real world object. A set of one or more scan descriptors may correspond to a particular snapshot of environmental data, and/or a portion of a stream of environmental data.

Using the scan descriptors, scan translator 214 can track the coverage of the environmental data with respect to the environment. In other words, scan augmenter 206 can use scan descriptors 238 to determine which areas of the physical environment are captured in scanned environmental features 236, and which areas of the physical environment have not been captured in scanned environmental features 236, or otherwise corresponding to insufficient data, even where some data is present (e.g., areas with insufficient depth information in order to identify one or more holes to fill with a reference object). In some cases, scan augmenter 206 uses this knowledge in determining augmentations for the scanned environmental features, such as to determine whether or not to perform reference object matching, where to performed reference object matching with respect to scanned geometry, and/or to evaluate matches of reference objects to scanned geometry.

Examples of information which may be included scan descriptors 238 and optionally leveraged by scan augmenter 206 to make such determinations for augmentations include real environmental lighting conditions, sensors settings or features, such as camera settings (e.g., exposure time, contrast, zoom level, white balance, ISO sensitivity, etc.), environmental location(s) (e.g., based on GPS coordinates and/or a determined or identified venue), and more.

Reference object identifier 216 is configured to identify one or more reference objects based on the scanned environmental features generated by scan translator 214 (e.g., in real-time during scanning). The reference objects can be selected or identified from reference objects 232. In some cases, reference objects 232 include a collection, catalogue, or library of 3D virtual objects. One or more of these 3D virtual objects may correspond to at least some portion of a real world object and/or environment. For example, a reference object may be generated using a 3D scanner, such as by scan augmenter 206 or another 3D scanning system. In some cases, a reference object is synthetic and may be created by a user via a 3D modeling or drafting program or otherwise. In some cases, reference objects 232 include a set of primitive reference objects or shapes. A primitive object can refer to a simplest (i.e. ‘atomic’ or irreducible) geometric object that the system can handle (e.g., draw, store). Examples of primitives are a sphere, a cone, a cylinder, a wedge, a torus, a cube, a box, a tube, and a pyramid. Other examples include stock objects, such as tables, chairs, faces, and the like.

Reference object identifier 216 may also determine or identify one or more of object attributes 234 based on the scanned environmental features generated by scan translator 214. Object attributes 234 can include a library, collection, or catalogue of textures, colors, sounds, movements, animations, decals, 3D riggings (animation rigging), and the like. In some cases, scan augmenter 206 extracts one or more of the object attributes 234 from one or more of reference objects 232 or other 3D virtual objects and incorporates them into the collection. In addition or instead, the object attributes can be stored in association with and/or mapped to corresponding ones of reference objects 232. For example, different textures or other attributes of object attributes 234 may be mapped to different portions of a 3D virtual object in reference objects 232.

Reference object identifier 216 identifies one or more of reference objects 232 based on an analysis of scanned environmental features 236. This can include comparing any combination of the 3D geometry and scanned attribute features in scanned environmental features 236 to corresponding features in reference objects 232 and/or object attributes 234. Based on the analysis, reference object identifier 216 may optionally determine a similarity score between one or more of the various features in scanned environmental features 236 and one or more of the various features in reference objects 232 and/or object attributes 234.

In some cases, reference object identifier 216 identifies, or selects, a highest ranked or scored reference object or object attribute, or combination thereof, to provide for scanned environmental features augmentation. As another example, multiple sets of one or more object features (i.e. reference objects, objects attributes, and/or combinations thereof) may be selected to provide options for scanned environmental features augmentation. For example, a predetermined number of top ranked sets may be selected and/or sets may be selected based on exceeding a threshold similarity score.

Thus, reference object identifier 216 may, in some cases, identify one or more of reference objects 232 for augmentation based on determining or identifying geometric similarities with scanned 3D geometry (e.g., a scanned mesh). This could include mesh fitting scanned 3D geometry data to reference 3D geometry data and evaluating the quality of the fit. In some cases, reference object identifier 216 may select one or more of reference objects 232 based on determining one or more object attributes 234 associated with the reference objects correspond to scanned environmental features 236. For example, reference object identifier 216 can use texture, colors, and the like in scanned environmental features 236 and match those features to corresponding object attributes which may be associated with a reference object.

Other semantic or contextual information may be evaluated by reference object identifier 216 in identifying or selecting reference objects and/or object attributes, such as scan descriptors 238. For example, reference object identifier 216 can compare scan descriptors 238 to contextual or semantic information associated with reference objects 232 and/or object attributes 234. To illustrate the forgoing, scan descriptors 238 may include location data, such as GPS coordinates or venue data. Reference object identifier 216 may associate this contextual data with one or more of reference objects 232 and select the reference objects based on the association. For example, reference object identifier 216 could determine that the user is at a location where users typically scan one or more of reference objects 232, such as based on scan descriptors from previous user scans. Thus, those reference objects may be selected or may be more likely to be selected for augmentation. This concept may be generalized to determining similarities in any combination of venue type, venue, lighting conditions, time stamps (e.g., time of year similarities), in order to select object attributes and/or reference objects.

To illustrate the forgoing, assume a user is scanning a cathedral. According to GPS data from the user device, reference object identifier 216 can determines other users have scanned the cathedral and select a reference object corresponding to the cathedral for augmentation. The cathedral being scanned can be autocompleted so the user doesn't have to go all around the cathedral to complete the scan.

Scan descriptors 238 may also be utilized by reference object identifier 216 to interpret scanned environmental features to understand which portions of the data are likely accurate and which portions are uncaptured or missing. In matching object features to corresponding scanned object features, these deficient portions of the data may optionally be accounted for in determining similarity scores.

In some cases, one or more of reference objects 232 and/or object attributes 234 are stored locally on a user device performing scanning, such as user device 102a. In addition, or instead, one or more of reference objects 232 and/or object attributes 234 may be located in cloud storage, such as on server 108. In some implementations, one or more of reference objects 232 and/or object attributes 234 are transferred to the user device from cloud storage, such as using application 110. For example, user device 102a may report its location (e.g., GPS coordinates) to server 108 (e.g., via application 110), and a set of one or more of reference objects 232 and/or object attributes 234 may be downloaded to the user device based on the location (and/or other contextual parameters). Reference object identifier 216 may then select from this set of reference objects for augmentation. This process may be initiated, for example, based on launching of application 110 or initiating of environmental scanning. In some cases, hashes of reference models could be created (e.g., for primitive objects or groupings thereof). When a user arrives at a certain location identified by the system, the hashes may be transferred to the device performing the scan to use as potential reference objects. Thus, server 108 could store many reference objects and transfer a subset to a user device based on scanning context. In some cases, matching occurs server side. For example, the server may receive a partially scanned model or object to match server side.

As mentioned above, scanned environment enhancer 220 is configured to augment scanned environmental features 236 using the one or more of reference objects 232 and/or object attributes 234 determined, identified, or selected by reference object identifier 216. The scanned environmental features 236 augmented with one or more of the selected features may be displayed to the user using scanning interface 218. In some cases, at least some augmented portions are visually indicated in the display, such as my being displayed in a visually distinguishable manner from scanned environmental features.

For example, FIG. 3B presents scanned geometry features and scanned attribute features of the scanned environmental features for scanned virtual object 302 in display 300B augmented with reference object 304. In the present example, reference object 304 is a cube primitive. Further, scanned environment enhancer 220 may have replaced portions of the 3D geometry for scanned virtual object 302 with reference object 304, as well as added to the scanned 3D geometry based on the geometry of reference object 304. In some cases, textures prior to augmentation may be interpolated onto added 3D geometry. Further, scanned environmental features corresponding to previously determined and/or rendered textures may be reevaluated, remapped, and/or predetermined based on the updated geometry, as shown. Because, for example, the tissue box is matched to a box, scan translator 214 can now determine edges at which the faces of the object should end and autocomplete texture or color to result in a higher quality object.

For example, FIG. 3A may correspond to environmental scanning with coverage 308 of the real world object corresponding to scanned virtual object 302. Therefore, certain portions of the real world object may not have been scanned, such as back of the object. This can result in visual artifacts in texture or coloration applied to scanned virtual object 302 (e.g., 2.5D pixel tearing due to insufficient geometry). For example, scanned environmental features 236 could correspond to a 2.5D environment which was captured by stereo camera or otherwise has severe restrictions on scene coverage. In FIG. 3B, there uncovered portions of the real world environment have been added to the scanned geometry. Thus, the texturing or coloration can be updated based on the additional geometric information, resulting in an improved scan. In this case pixel stretching due to lack of data behind the object has been removed.

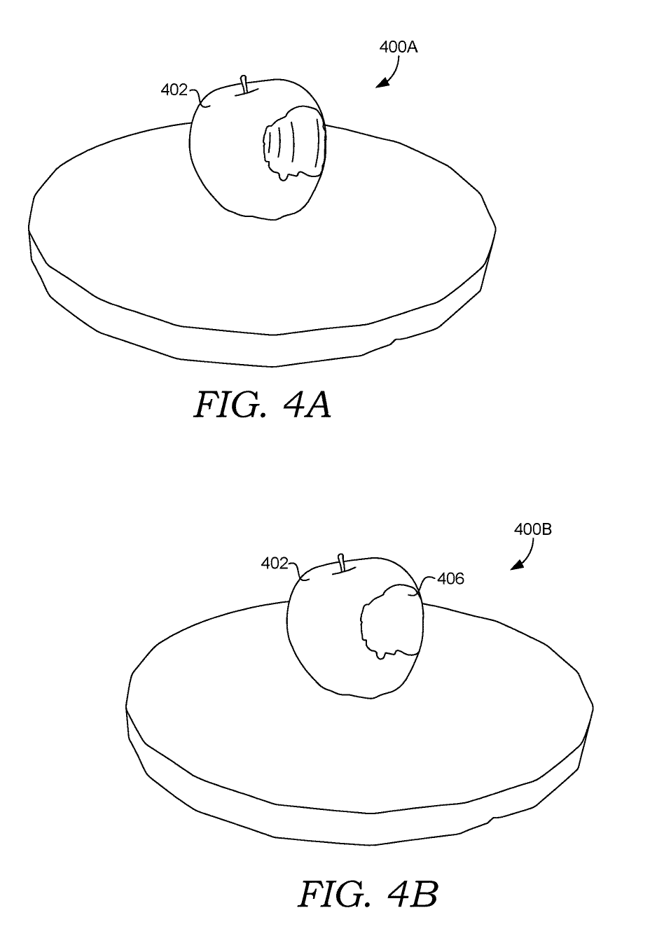

FIGS. 4A and 4B illustrate another example of augmenting 3D virtual objects based on reference objects. Display 400A of FIG. 4A shows presents scanned geometry features and scanned attribute features of the scanned environmental features for scanned virtual object 402 having hole 404 due to insufficient scanning conditions. Display 400B of FIG. 4B shows presents scanned geometry features and scanned attribute features of the scanned environmental features for scanned virtual object 402 having been completed by scanned environment enhancer 220 with augmented geometry 406 based on a reference object.

Scanned environment enhancer 220 can perform the augmentations to scanned environmental features 236 (e.g., in real-time during a live scan of the environment) by, for example, mesh fitting one or more of the selected reference objects to the scanned 3D geometry. This can result in a hybrid object including some portions of scanned geometry and some portions of reference geometry and/or other object features. In some cases, scanned environment enhancer 220 performs the augmentation by merging one or more portions of the reference object with the scanned 3D geometry and/or other scanned features. To correct gaps in geometry, such as hole 404, scanned environment enhancer 220 could, for example, complete the gaps with geometry based on or from one or more selected reference objects.

In some implementations, scanned environment enhancer 220 may use a library object texture (e.g., a selected reference object texture), and generate texture for the scanned 3D virtual object using the surrounding textures in the library object, and perform transition smoothing between them. As another option, one or more solid textures or colors could be used, or a wireframe of the 3D object could be used and rendered.

In some cases, scanned environment enhancer 220 automatically applies the augmentations to the scanned environmental features. In others, some user selection or other input is employed first to allow the user to select between augmentation options, such as those for particular areas or regions of a 3D model, or for the 3D model overall. As an example, a user could be provided with different reference objects to select for augmentation and/or different combinations of object attributes, such as textures for augmented regions of the 3D model and the like.

Using implementations of the present disclosure, it should be appreciated that scanned environmental data can be linked up with richer datasets than what is available from the scan data also. Thus, scans an action figure, a user may be presented in the scanning interface with an option to produce or download an action figure model that animates with a set of animations that were created for the model. These types of object attributes could would not be available with just scan data but with the matching described herein, not only may models be completed or replaced with a better version, but the resultant objects can be associated with or contain content that otherwise would not be accessible directly from the scanned data.

Further, assume a user is scanning his wife in front of a statue and his wife is obscuring part of the statue. If the user would like portions of geometry and other features that are blocked by his wife in a 3D model, aspects of this disclosure allow that information to be captured in the 3D model.

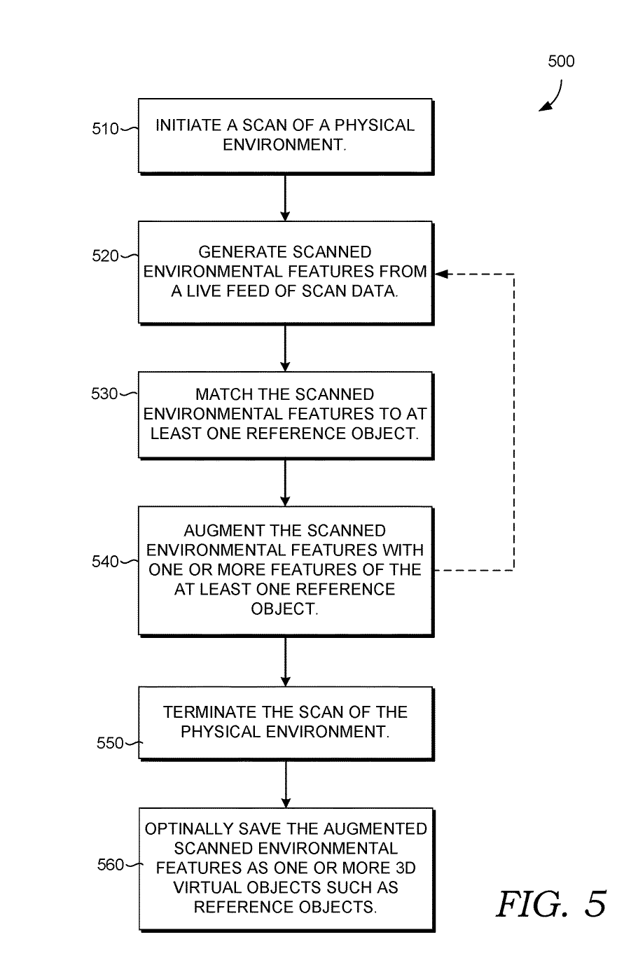

Referring now to FIG. 5, a flow diagram is provided showing an embodiment of a method 500 in accordance with disclosed embodiments. Each block of method 500 and other methods described herein comprises a computing process that may be performed using any combination of hardware, firmware, and/or software. For instance, various functions may be carried out by a processor executing instructions stored in memory. The methods may also be embodied as computer-usable instructions stored on computer storage media. The methods may be provided by a standalone application, a service or hosted service (standalone or in combination with another hosted service), or a plug-in to another product, to name a few.

At block 510, method 500 includes initiating a scan of a physical environment. For example, environmental scanner 212 can initiate a scan of a physical environment, which may be performed by a depth-sensing camera of user device 110. A user of user device 110 may initiate the scan via scanning interface 218.

At block 520, method 500 includes generating scanned environmental features from a live feed of scan data. For example, scan translator 214 can generate scanned environmental features 236 from the scan data provided by the scan of the physical environment.

At block 530, method 500 includes matching the scanned environmental features to at least one reference object. For example, reference object identifier 216 can match scanned environmental features 236 to one or more of reference objects 232.

At block 540, method 500 includes augmenting the scanned environmental features with one or more features of the at least one reference object. For example, scanned geometry enhancer 220 can augment scanned environmental features 236 with one or more features of the matched one or more of reference objects 232. Optionally, the segmented scanned environmental features may be displayed and/or presented on a user device, such as via scanning interface 218. Optionally, blocks 520, 530, and 540 may repeat as the physical environment is further scanned, as indicated in FIG. 5.

At block 550, method 500 includes terminating the scan of the physical environment. For example, environmental scanner 212 may terminate the scan of the physical environment.

At block 560, method 500 includes optionally saving the augmented scanned environmental features as one or more 3D virtual objects. For example, scanning interface 218 may create one or more new 3D virtual objects and/or designate the one or more new 3D virtual objects as reference objects, which may potentially be matched to scan data from future scans.

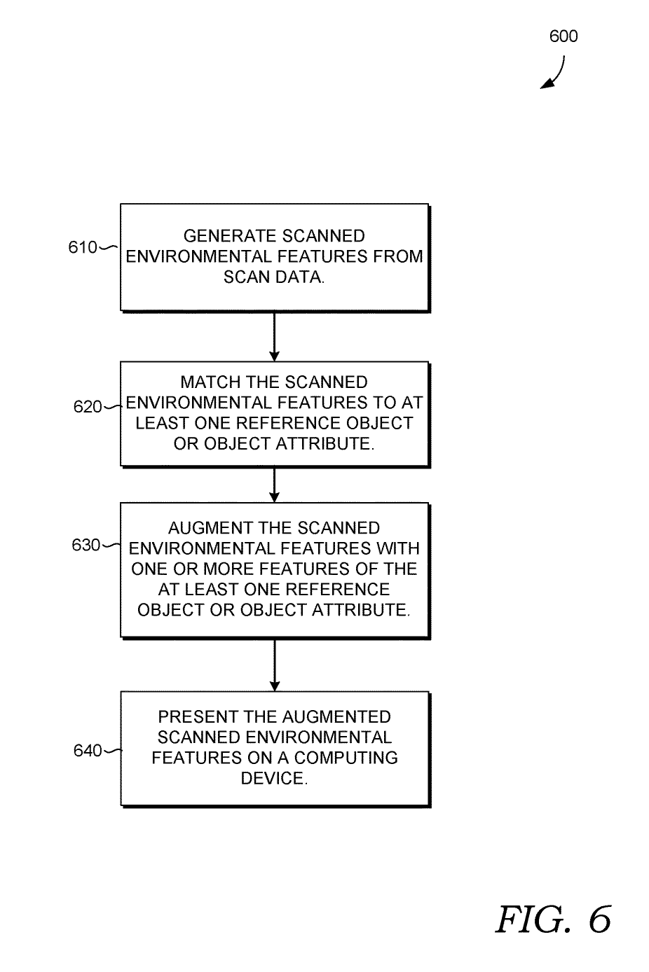

Referring to FIG. 6, a flow diagram is provided showing an embodiment of a method 600 in accordance with disclosed embodiments. At block 610, method 600 includes generating scanned environmental features from scan data. For example, scan translator 214 can generate scanned environmental features 236 from scan data provided by environmental scanner 212.

At block 620, method 600 includes matching the scanned environmental features to at least one reference object or object attribute. For example, reference object identifier 216 can match scanned environmental features 236 to one or more of reference objects 232 and/or object attributes 234.

At block 630, method 600 includes augmenting the scanned environmental features with one or more features of the at least one reference object or object attribute. For example, scanned geometry enhancer 220 can augment scanned environmental features 236 with one or more features of the one or more of reference objects 232 and/or object attributes 234.

At block 640, method 600 includes presenting the augmented scanned environmental features on a computing device. For example, application 110 and/or scanning interface 218 can present the augmented scanned environmental features on user device 102a.

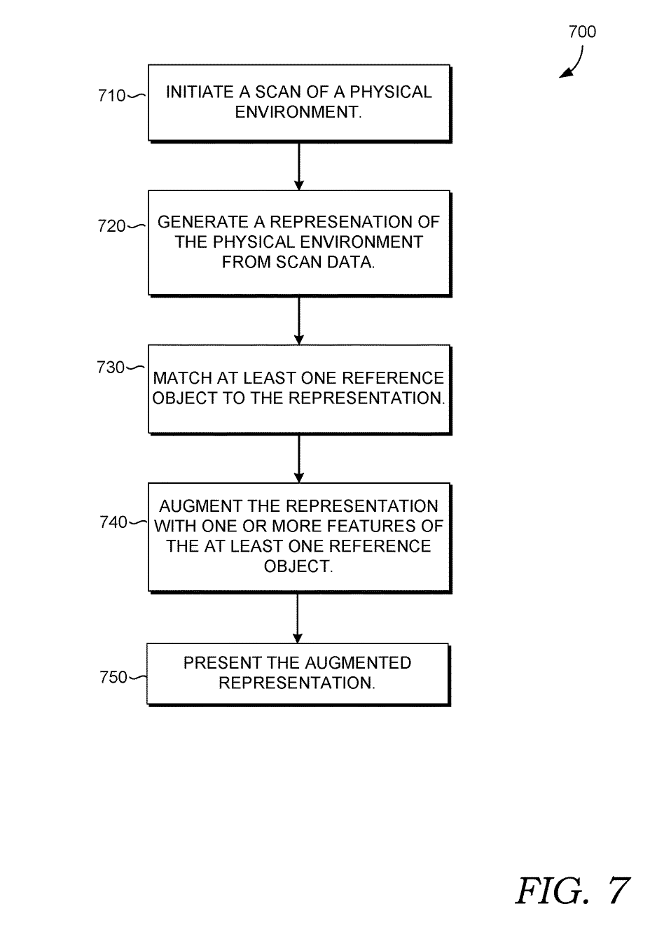

Referring to FIG. 7, a flow diagram is provided showing an embodiment of a method 700 in accordance with disclosed embodiments. At block 710, method 700 includes initiating a scan of a physical environment. At block 720, method 700 includes generating a representation of the physical environment from scan data. At block 730, method 700 includes matching at least one reference object to the representation. At block 740, method 700 includes augmenting the representation with one or more features of the at least one reference object. At block 750, method 700 includes presenting the augmented representation.

With reference to FIG. 8, computing device 800 includes bus 810 that directly or indirectly couples the following devices: memory 812, one or more processors 814, one or more presentation components 816, input/output (I/O) ports 818, input/output components 820, and illustrative power supply 822. Bus 810 represents what may be one or more busses (such as an address bus, data bus, or combination thereof). Although the various blocks of FIG. 8 are shown with lines for the sake of clarity, in reality, delineating various components is not so clear, and metaphorically, the lines would more accurately be grey and fuzzy. For example, one may consider a presentation component such as a display device to be an I/O component. Also, processors have memory. The inventors recognize that such is the nature of the art and reiterate that the diagram of FIG. 8 is merely illustrative of an exemplary computing device that can be used in connection with one or more embodiments of the present invention. Distinction is not made between such categories as “workstation,” “server,” “laptop,” “handheld device,” etc., as all are contemplated within the scope of FIG. 8 and reference to “computing device.”

Computing device 800 typically includes a variety of computer-readable media. Computer-readable media can be any available media that can be accessed by computing device 800 and includes both volatile and nonvolatile media, removable and non-removable media. By way of example, and not limitation, computer-readable media may comprise computer storage media and communication media. Computer storage media includes both volatile and nonvolatile, removable and non-removable media implemented in any method or technology for storage of information such as computer-readable instructions, data structures, program modules, or other data. Computer storage media includes, but is not limited to, RAM, ROM, EEPROM, flash memory or other memory technology, CD-ROM, digital versatile disks (DVDs) or other optical disk storage, magnetic cassettes, magnetic tape, magnetic disk storage or other magnetic storage devices, or any other medium which can be used to store the desired information and which can be accessed by computing device 800. Computer storage media does not comprise signals per se. Communication media typically embodies computer-readable instructions, data structures, program modules, or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media, such as a wired network or direct-wired connection, and wireless media, such as acoustic, RF, infrared, and other wireless media. Combinations of any of the above should also be included within the scope of computer-readable media.

Memory 812 includes computer storage media in the form of volatile and/or nonvolatile memory. The memory may be removable, non-removable, or a combination thereof. Exemplary hardware devices include solid-state memory, hard drives, optical-disc drives, etc. Computing device 800 includes one or more processors that read data from various entities such as memory 812 or I/O components 820. Presentation component(s) 816 present data indications to a user or other device. Exemplary presentation components include a display device, speaker, printing component, vibrating component, etc.

I/O ports 818 allow computing device 800 to be logically coupled to other devices including I/O components 820, some of which may be built in. Illustrative components include a microphone, joystick, game pad, satellite dish, scanner, printer, wireless device, etc. I/O components 820 may provide a natural user interface (NUI) that processes air gestures, voice, or other physiological inputs generated by a user. In some instances, inputs may be transmitted to an appropriate network element for further processing. An NUI may implement any combination of speech recognition, touch and stylus recognition, facial recognition, biometric recognition, gesture recognition both on screen and adjacent to the screen, air gestures, head and eye tracking, and touch recognition associated with displays on computing device 800. Computing device 800 may be equipped with depth cameras, such as stereoscopic camera systems, infrared camera systems, RGB camera systems, and combinations of these, for gesture detection and recognition. Additionally, computing device 800 may be equipped with accelerometers or gyroscopes that enable detection of motion. The output of the accelerometers or gyroscopes may be provided to the display of computing device 800 to render immersive augmented reality or virtual reality.

Many different arrangements of the various components depicted, as well as components not shown, are possible without departing from the scope of the claims below. Embodiments of the present invention have been described with the intent to be illustrative rather than restrictive. Alternative embodiments will become apparent to readers of this disclosure after and because of reading it. Alternative means of implementing the aforementioned can be completed without departing from the scope of the claims below. Certain features and sub-combinations are of utility and may be employed without reference to other features and sub-combinations and are contemplated within the scope of the claims.

What is claimed is:

1. A computer-implemented method comprising:
initiating, by a user device, a scan of a physical environment, the scan producing a live feed of scan data corresponding to the physical environment;
generating a three-dimensional (3D) representation of the physical environment from the live feed of scan data;
matching the scan data to at least one reference 3D object during the scan of the physical environment;
augmenting the 3D representation with 3D geometry of the at least one reference 3D object based on the matching; and
displaying the augmented 3D representation on the user device.

2. The method of claim 1, wherein the matching is of 3D geometry of the physical environment captured by the scan data to the 3D geometry of the at least one reference 3D object.

3. The method of claim 1, wherein the matching comprises mesh fitting the 3D representation to the 3D geometry of the at least one reference 3D object.

4. The method of claim 1, wherein the generated 3D representation corresponds to a partial scan of a real world object in the physical environment.

5. The method of claim 1, wherein the augmenting incorporates at least some of the 3D geometry of the at least one reference 3D object into the 3D representation.

6. The method of claim 1, wherein the augmenting of the 3D representation replaces at least some of the 3D representation with at least some of the 3D geometry of the at least one reference 3D object.

7. The method of claim 1, wherein the augmenting of the 3D representation adds at least some of the 3D geometry of the at least one reference 3D object to the 3D representation.

8. The method of claim 1, wherein the matching of the is based on determining the at least one reference 3D object is associated with a location corresponding to the user device.

9. The method of claim 1, further comprising:
providing, by the user device, scanning context of the scan to a server; and
receiving, from the server, a subset of reference objects from a collection of reference objects in response to the providing of the scanning context, wherein the matching uses the at least one reference 3D object from the received subset of reference objects.

10. The method of claim 1, wherein the matching is based on determining, from location data of the user device, the at least one reference 3D object corresponds to previous scans of the physical environment performed in association with other users.

11. A computer-implemented system comprising:
one or more processors; and
one or more computer storage media storing computer-useable instructions that, when executed by the one or more processors, cause the one or more processors to perform operations comprising:
generating a representation of a physical environment from scan data corresponding to the physical environment;
matching the generated representation of the physical environment to at least one reference 3D object;
augmenting the representation of the physical environment with one or more features of the at least one reference 3D object based on the matching; and
presenting the augmented representation of the physical environment on a user device.

12. The system of claim 11, wherein the augmenting of the representation assigns a set of 3D animations of the augmented representation to the augmented representation based on the matching.

13. The system of claim 11, wherein the augmenting the representation comprises interpolating texture of the representation onto added 3D geometry corresponding to the 3D geometry of the at least one reference 3D object.

14. The system of claim 11, wherein the augmenting is based on a user selection of an option corresponding to the one or more features from a plurality of options provided for augmenting the representation.

15. The system of claim 11, wherein the matching is of 3D geometry of the representation of the physical environment to 3D geometry of the at least one reference 3D object.

16. One or more computer-readable media having executable instructions embodied thereon, which, when executed by one or more processors, cause the one or more processors to perform a method, the method comprising:
receiving scan data corresponding to a physical environment, the scan data capturing 3D geometry of the physical environment;
matching the captured 3D geometry from the scan data to at least one reference 3D object;
augmenting the captured 3D geometry of the physical environment with one or more features of the at least one reference 3D object based on the matching; and
presenting the augmented 3D geometry of the physical environment on a user device.

17. The one or more computer-readable media of claim 16, wherein the one or more features comprise a texture of the at least one reference 3D object.

18. The one or more computer-readable media of claim 16, wherein the one or more features comprise 3D geometry of the at least one reference 3D object.

19. The one or more computer-readable media of claim 16, wherein the method further comprises determining a similarity score between the captured 3D geometry and the at least one reference 3D object, wherein the matching is based on the determined similarity score.

20. The one or more computer-readable media of claim 16, wherein the 3D geometry of the physical environment corresponds to depth information from a depth-sensing camera.
